(19) United States
(12) Patent Application Publication
(10) Pub. No.: US 2005/0071665 A1
(43) Pub. Date: Mar. 31, 2005

(54) Methods and apparatus to associate boot objects with trust credentials

(76) Inventors: Vincent J. Zimmer, Federal Way, WA (US); Michael A. Rothman, Gig Harbor, WA (US)

Correspondence Address: GROSSMAN & FLIGHT LLC;Suite 4220, 20 North Wacker Drive, Chicago, IL, 60606-6357, US

(21) Appl. No.: 10/675,508

(22) Filed: Sep. 30, 2003

(51) Int. Cl. H04L 9/32

(52) U.S. Cl. 713/200; 713/2

(57) ABSTRACT

Methods and apparatus to associate boot objects with trust credentials are disclosed. In one example a method of booting a processor system includes accepting a selection of a desired operating system to be booted, accepting a user credential associated with a user who has selected the desired operating system to be booted, and determining if the user credential corresponds to the desired operating system to be booted. Additionally, the example disclosed method includes enabling booting of the desired operating system if the user credential corresponds to the desired operating system.

### TECHNICAL FIELD

The present disclosure pertains to computing systems and, more particularly, to methods and apparatus to associate boot objects with trust credentials.

### BACKGROUND

Historically, a given computer platform had only one configuration that did not change depending on the preferences of various users. For example, the disk operating system (DOS)-based systems of the mid to late 1980s did not account for user preferences and did not typically have any consideration for user identity or the preferences of users with regard to user interface issues.

As operating system (OS) software evolved from DOS to Windows-based platforms, it became possible for one platform (i.e., computer) to accommodate a number of different users. One platform could be used by multiple users at different times and the preferences of those users were associated with login information for those users. For example, a first user's preferences with regard to platform screen saver, font, window colors, etc. could be applied when the first user logged into the platform. Similarly, a second user's preferences for screen saver, font, window color, etc. could be maintained by the platform and applied when the second user logged into the platform.

As computing systems have evolved; so have operating systems. For example, operating systems such as Windows 98, Windows NT®, Windows XP®, Linux, etc. are widely used throughout the relevant computing public. Each of these operating systems has particular operational aspects in which it excels. For example, it is widely known that Windows XP® is useful for productivity packages, such as Microsoft Office XP®. Likewise, it is known that Windows 98 excels in the handling of personal computer (PC) gaming software. Given the rapid pace at which hardware capabilities have progressed, it is now possible to have a number of different operating systems resident on a single platform.

### BRIEF DESCRIPTION OF THE DRAWINGS

FIG. 1 is a diagram of an example processor system.

FIG. 2 is a block diagram of an example operating system boot process.

FIG. 3 is a block diagram of the example boot selector operating on the processor of FIG. 2.

FIGS. 4A and 4B, collectively FIG. 4, form a flow diagram of an example boot process that may be carried out by the processor of FIG. 1.

FIG. 5 is a flow diagram showing additional detail of the example update trust credentials process shown in FIG. 4.

### DETAILED DESCRIPTION

Although the following discloses example systems including, among other components, software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware, and/or software. Accordingly, while the following describes example systems, persons of ordinary skill in the art will readily appreciate that the examples provided are not the only way to implement such systems.

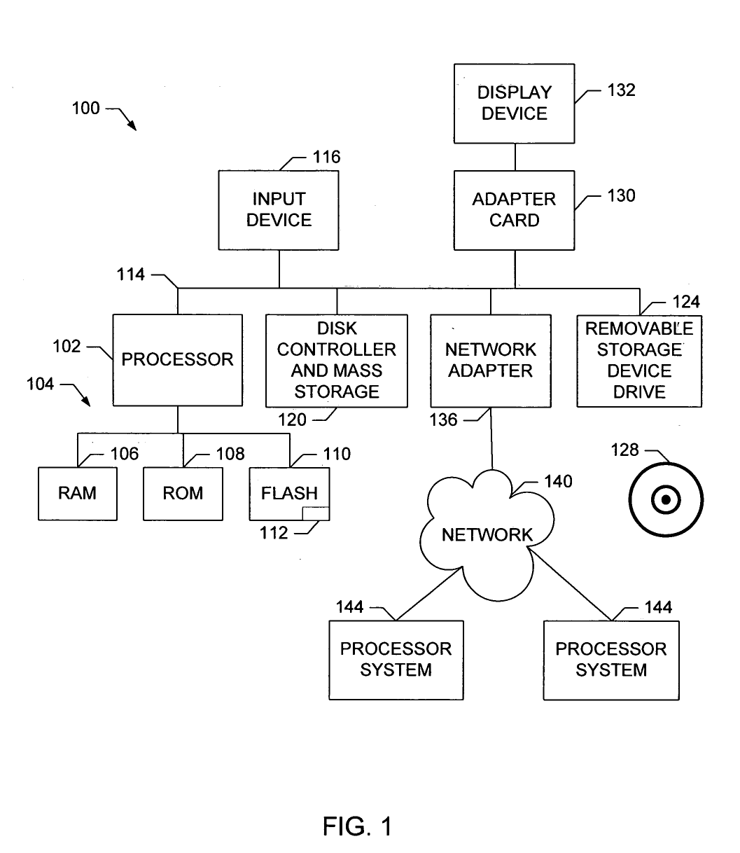

Turning now to FIG. 1, an example processor system 100 includes a processor 102 having associated system memory 104. The system memory 104 may include one or more of a random access memory (RAM) 106, a read only memory (ROM) 108 and a flash memory 110. The flash memory 110 of the illustrated example includes a boot block 112 that stores instructions used to establish a pre-boot environment prior to commencing OS loading.

The processor 102, in the example of FIG. 1, is coupled to an interface, such as a bus 114 to which other peripherals or devices are interfaced. In the illustrated example, the peripherals interfaced to the bus 114 include an input device 116, a disk controller and mass storage device 120, and a removable storage device drive 124. The removable storage device drive 124 may include associated removable storage media 128, such as magnetic, solid state, or optical media.

The example processor system 100 of FIG. 1 also includes an adapter card 130, which is a peripheral coupled to the bus 114 and further coupled to a display device 132. Together, the adapter card 130 and the display device 132 provide,a user interface through which a user can be provided information from the processor 102.

The example processor system 100 may be, for example, a conventional desktop personal computer, a notebook computer, a workstation, or any other computing device. The processor 102 may be any type of processing unit, such as a microprocessor from the Intel® Pentium® family of microprocessors, the Intel® Itanium® family of microprocessors, and/or the Intel XScale® family of processors. Alternatively or additionally, the processor 102 may be implemented using any processor available from Intel® or from any other manufacturer.

The memories 106, 108, and 110, which form some or all of the system memory 104, may be any suitable memory devices and may be sized to fit the storage demands of the system 100. The RAM 106 may be implemented using a dynamic random access memory (DRAM), a static random access memory (SRAM), or any other suitable memory device.

The flash memory 110 is a low-cost, high-density, high-speed architecture having low power consumption and high reliability. The flash memory 110 is a non-volatile memory that is accessed and erased on a block-by-block basis. In some situations, the boot block 112 of the flash memory 110 may contain pre-boot instructions that may be used to establish a pre-boot environment within the processor 102 when the instructions are executed. For example, the pre-boot instructions may be used to establish a basic input/output system (BIOS) and/or any other pre-boot environment such as the extensible firmware interface (EFI). As will be readily appreciated by those having ordinary skill in the art, the pre-boot environment is a link between the hardware interfaces and the processor 102 before an OS is loaded. The pre-boot environment is replaced by an OS that is typically loaded as a part of the last instruction of the pre-boot phase of processor operation.

The input device 116 may implemented by a keyboard, a mouse, a touch screen, a track pad, or any other device that enables a user to provide information to the processor 102.

The adapter card 130 may be any standard, commercially available adapter card that is used to interface the processor 102 to the display device 132. The display device 132 may be, for example, a liquid crystal display (LCD) monitor, a cathode ray tube (CRT) monitor, or any other suitable device that acts as an interface between the processor 102 and a user via the adapter card 130. The adapter card 130 is any device used to interface the display device 132 to the bus 114. Such cards are presently commercially available from, for example, Creative Labs and other like vendors.

The mass storage device 120 may be, for example, a conventional hard drive or any other magnetic or optical media that is readable by the processor 102. For example, the mass storage device 120 may be a hard drive having storage capacity on the order of hundreds of megabytes to tens or hundreds of gigabytes.

The removable storage device drive 124 may be, for example, an optical drive, such as a compact disk-recordable (CD-R) drive, a compact disk-rewritable (CD-RW) drive, a digital versatile disk (DVD) drive, or any other optical drive. It may alternatively be, for example, a magnetic or solid state media drive. The removable storage media 128 is complimentary to the removable storage device drive 124, inasmuch as the media 128 is selected to operate with the drive 124. For example, if the removable storage device drive 124 is an optical drive, the removable storage media 128 may be a CD-R disk, a CD-RW disk, a DVD disk or any other suitable optical disk. On the other hand, if the removable storage device drive 124 is a magnetic media device, the removable storage media 124 may be, for example, a diskette or any other suitable magnetic storage media.

The example processor system 100 also includes a network adapter 136 such as, for example, an Ethernet card or any other card that may be wired or wireless. The network adapter 136 provides network connectivity between the processor 102 and a network 140, which may be a local area network (LAN), a wide area network (WAN), the Internet, or any other suitable network. As shown in FIG. 1, further processor systems 144 may be coupled to the network 140, thereby providing for information exchange between the processor 102 and the processors of the processor systems 144.

As described in detail hereinafter, the disclosed systems and methods enable the processor 102 receive information from a user in a pre-boot environment and to boot one of a number of operating systems based on the user information. In one example, the user information includes a user trust credential such as a user name, a password, a portable token, and/or biometric information (e.g., fingerprints, retinal scans, etc.) In such an example, the user may also provide an indication of a desire to boot a particular OS. Alternatively, the OSs that may be booted by a particular user may be tied to user credentials (also referred to herein as trust credentials) by a platform owner during an administrative action session and the user may have no participation in selecting an OS to be booted. According to the disclosed systems and methods, users having credentials that are not authorized to boot certain OSs are prevented from booting the unauthorized OSs.

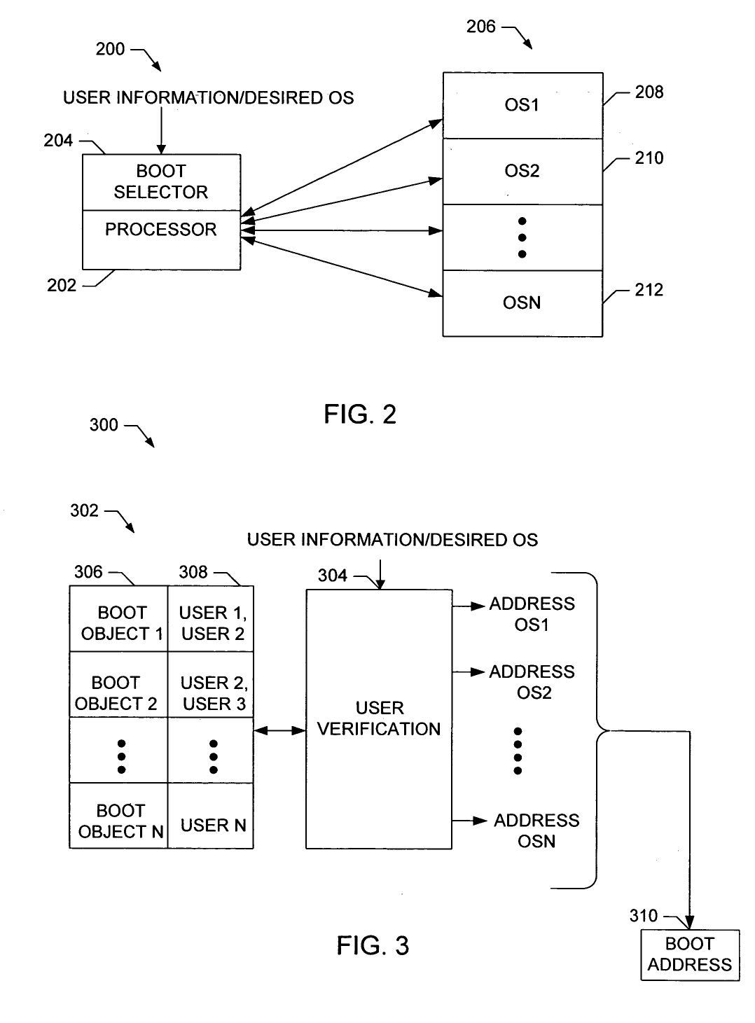

As shown in FIG. 2, in a block diagram of a boot process 200, a processor 202, which may be implemented using the processor 102 of FIG. 1, includes a boot selector 204 that may be implemented by firmware instructions executed by the processor 202. Also shown in FIG. 2 are a number of OSs 206 that may be, for example, stored on the mass storage 120 of FIG. 1. In particular, the number of OSs 206 includes OS1 208, OS2 210, and a number of other OSs, the last one of which is referred to as OSN 212. In general, during operation, which takes place in a pre-boot environment, the boot selector 204 receives user information and/or an indication of a desired OS and compares the user information and/or the desired OS to a permissions table. Based on the user information, the boot selector 204 instructs the processor 202 as to which OS of a number of OSs 206 to boot. For example, a user named Johnny having a certain password may only have permissions to boot OS1 208, which may be a Windows 98 operating system. Accordingly, when the boot selector 204 receives Johnny's credentials (e.g., a user name, a password, or another identifying information), the boot selector 204 instructs the processor 202 to boot OS1 208. After receiving the indication to boot OS1 208, the processor 202 prepares to boot OS1 208 and eventually kills the pre-boot environment to boot OS1 208.

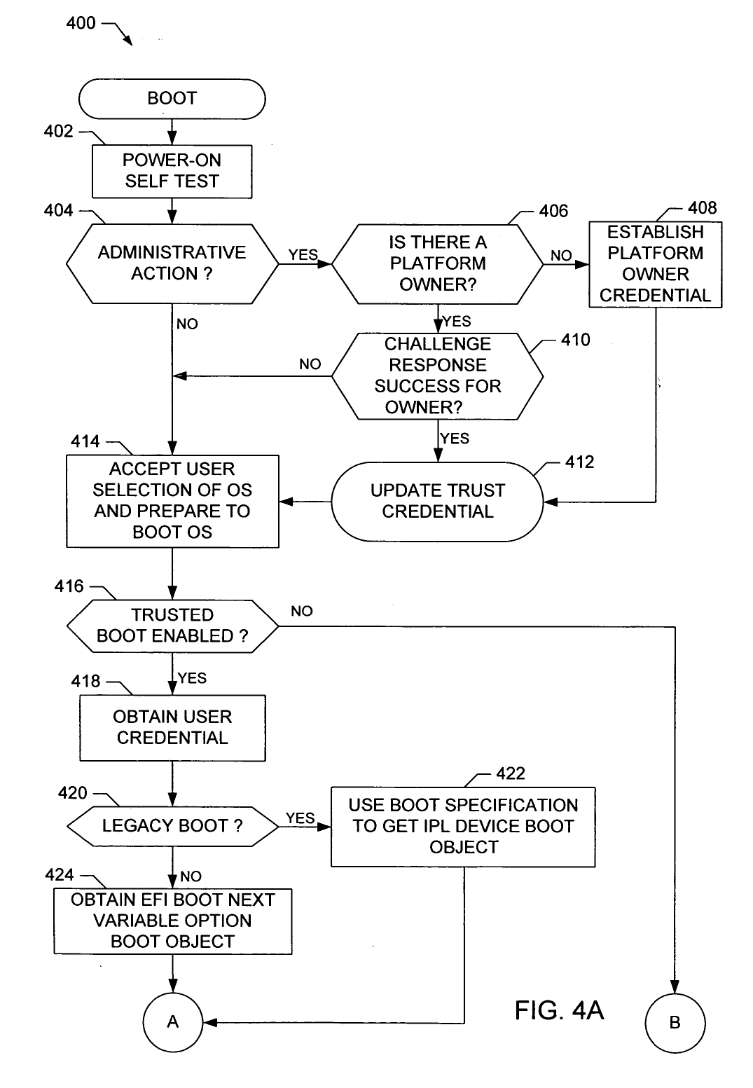

Referring to FIG. 3, further detail of a boot selector 300, which may be used to implement the boot selector 204 of FIG. 2, reveals a permissions table 302 coupled to a user verification segment 304. In one example, as shown in FIG. 3, the permissions table 302 includes two columns of information 306 and 308. The column 306 includes boot objects corresponding to operating systems that may be loaded by a processor (e.g., the processor 202). As will be readily appreciated by those having ordinary skill in the art, the boot objects may be one or more of BIOS boot specifications (BBS) and/or EFI boot option targets.

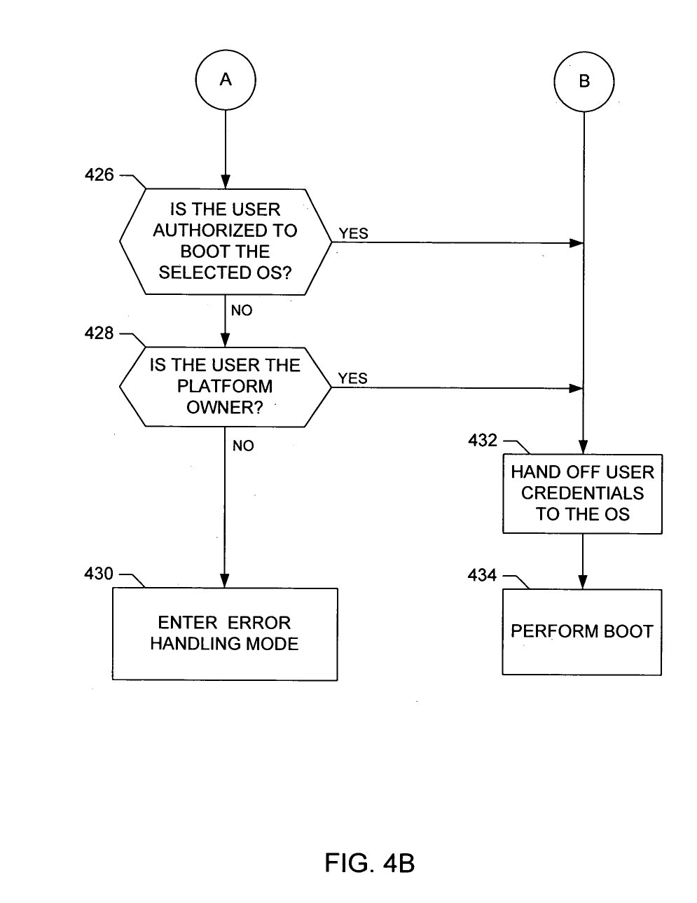

In general, the user verification segment 302 receives the user information and/or the desired OS (e.g., user credentials) and compares the received user credentials against the contents of the permissions table 302. Based on the results of the comparison, the user verification segment 302 provides an OS boot address 310 to the processor (e.g., the processor 202 of FIG. 2). The processor then uses the boot address 310 to boot the OS corresponding to the boot address 310. For example, if the user credentials indicate that the user is user 3 and that user 3 desires to boot an OS referred to as OS 2, the user verification segment 302 determines that user 3 is authorized to boot OS 2 and provides a boot address corresponding to OS 2 to the processor. In one example, the boot address may be provided in the form of a boot object. In contrast, however, if the user credentials had indicated that user 3 desires to boot an OS referred to as OS 1, the user verification segment 302 would not provide a boot address of OS 1 to the processor because, according to the permissions table 302, user 3 is only authorized to boot OS 2. Mismatches between the user credentials and the desired OS may be handled by simply booting the OS for which the user has permission, or by failing to load an OS and providing an indication to the user (e.g., via an on screen display) that he/she doesf not have permission to boot the desired OS. In such an example, the user may be provided an option to designate an alternate OS that the user has permission to boot. Further detail pertinent to the various operational aspects is provided below in conjunction with the flow diagrams of FIGS. 4A-4B.

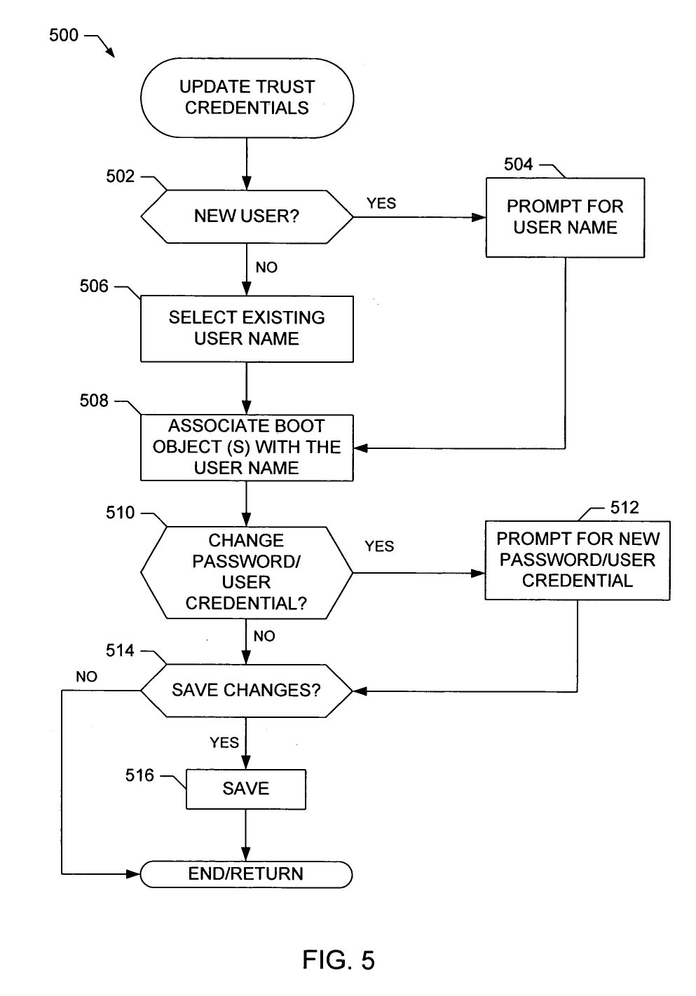

An example boot process 400 is illustrated in detail in FIGS. 4A and 4B, and an example update user trust credentials process 500 is illustrated in detail in FIG. 5. The boot process 400 and/or the update user trust credentials process 500 may be implemented using one or more firmware or software programs or sets of instructions that are stored in one or more memories (e.g., the memories 106, 108, and/or 110 of FIG. 1) and executed by one or more processors (e.g., the processor 102 of FIG. 1 and/or the processor 202 of FIG. 2) in a pre-boot environment. However, it is possible that, in some arrangements, some or all of the blocks of the boot process 400 and/or the update user trust credentials process 500 may be performed manually and/or by some other device. Additionally, although the boot process 400 and the update user trust credentials process 500 are described with reference to the flowcharts illustrated in FIGS. 4A-4B, persons of ordinary skill in the art will readily appreciate that many other methods of performing the boot process 400 and the update user process 500 may be used. For example, the order of many of the blocks may be altered, the operation of one or more blocks may be changed, blocks may be combined, and/or blocks may be eliminated. Furthermore, while the boot process 400 is shown as being a separate process from the update trust credentials process 500, those having ordinary skill in the art will readily recognize that the two processes could be combined and represented in a single diagram.

As will be readily appreciated by those having ordinary skill in the art, the boot process 400 may be commenced when a processor (e.g., the processor 102 of FIG. 1) receives a reset signal, which may be due to power application or interruption or any other event that causes a reset line of the processor to be held in a reset condition. When the processor experiences a reset, the processor begins execution by reading firmware instructions from a boot block (e.g., the boot block 112 stored in the flash memory 110 of FIG. 1). Accordingly, the boot process 400 may be implemented using firmware instructions stored in the boot block of the flash memory 110 and executed in a pre-boot environment.

The boot process 400 begins with a commencement of a power-on self test (block 402), during which various memories and/or registers may be initialized and tested. The power-on self test may check the integrity of various portions of the processor and/or components coupled to the processor.

After the power-on self-test has completed (block 402), the boot process 400 determines if an administrative action has taken place (block 404). In one example, an administrative action may be commenced by a user or administrator actuating a particular keyboard key during a pre-boot sequence of processor operation. For example, at a particular point in time of the pre-boot process a user may be prompted to actuate the F1 key to enter an administrative mode.

If an administrative action has taken place (block 404), the boot process 400 determines if an owner has been established for the platform (i.e., a platform owner) (block 406). A platform owner may be thought of as an administrator or a super user having full rights to take action on the platform. For example, in a family situation, one of the parents may be the platform owner who sets access control properties for any children within the household. If no platform owner has been established (block 406), the user enters platform credentials (block 408), which may be, for example, a user name, a password, a salted password, or any other credential(s) such as, for example, the use of a universal serial bus (USB) dongle having a code stored therein. Additionally, the user credential could be biometric information such as fingerprints or retinal scans, etc. The established platform owner credential may be any criteria that will be tested by the platform to ensure that a user seeking platform ownership is in fact the platform owner. For example, if a USB dongle is used to establish platform ownership, that same USB dongle will be required to assert platform ownership in the future.

Alternatively, if a platform owner has been previously established (block 406), the platform issues a challenge to the user attempting to assert that he/she is the platform owner (block 410). The challenge must be any criteria that was used previously to establish platform ownership (such as, for example, in block 408).

After either user platform credentials are established (block 408) or after a user provided a successful challenge response (block 410), an update trust credentials process (block 412) is carried out. One example of an update trust credentials process is shown and described in conjunction with FIG. 5. In general, the update trust credentials process enables the platform owner to add or remove user names from a list and further allows the platform owner to associate boot objects, and, therefore, operating systems, with user names.

If administrative action is not selected (block 404) or after the update trust credentials process (block 412) has completed, the boot process accepts a user selection of an OS to boot and prepares to boot the selected operating system (block 414). After the OS to be booted is selected, the boot process 400 determines if a trusted boot is enabled (block 416). In general, when trusted boot is enabled, user credentials are examined and it is determined if a user has permission to boot a particular operating system. In the alternative, if trusted boot is not enabled, user credentials are not examined and the OS selected for boot (block 414) is booted by the processor.

In particular, if trusted boot is enabled (block 416), the boot process 400 requests and obtains user credentials from the user (block 418). As noted previously, user credentials may be user names, passwords, USB dongles, or any other type of device or information that uniquely identifies a user. After the credentials are obtained (block 418), the boot process 400 determines if the OS to be booted requires a legacy boot (block 420). A legacy boot is a boot carried out by a legacy firmware system, such as any pre-EFI firmware system like a BIOS boot specification-based system. If a legacy boot is required, the boot process 400 uses a boot specification (e.g., a BBS) to get the initial program load (IPL) device boot object (block 422). In the alternative, if a legacy boot is not required, the boot process 400 obtains an EFI boot next variable option boot object (block 424). Generally speaking, the blocks 422 and 424 may be characterized as obtaining an operating system boot object, whether that boot object is a legacy boot object (e.g., a BBS boot object) or a non-legacy boot object (e.g., an EFI boot object).

After either the legacy or non-legacy boot object has been obtained (block 422 or block 424), the boot process 400 determines if the user (as identified by the user credentials of block 418) is authorized to boot the selected OS (block 426). The determination as to authorization may be made by comparing the desired OS to the list of OSs that the user is authorized to boot. For example, referring back to FIG. 2, a permission table 302 may be maintained and administered by a platform owner via the update trust credentials process (block 412 and/or an example of the same shown in FIG. 4B).

If the user is not authorized to boot the selected OS (block 426), the boot process 400 determines if the user is the platform owner (block 428). If the user is not the platform owner (block 428), the boot process 400 enters an error handling mode (block 430) in which the user is informed of his/her lack of authorization to boot the desired OS. In the error handling mode, the user may be provided the opportunity to change his/her user credentials and/or desired boot OS. Although not shown in FIG. 4, the change of either of these two pieces of information may cause the user to be directed back to the block 414 of the boot process 400. Alternatively, the user may be directed back to the block 402 of the boot process 400 where the system will appear as if it has been reset.

Conversely, if the trusted boot is not enabled (block 416 of FIG. 4A), or if the user is authorized to boot the selected OS (block 426 of FIG. 4B), or if the user is the platform owner (block 428 of FIG. 4B), the user credentials are handed off to the OS to be booted (block 432) and the boot of the selected OS is performed (block 434), thereby terminating the pre-boot environment. Of course, the handoff of the user credentials is an optional part of the boot process 400.

An example update trust credentials process 500 as shown in FIG. 5 begins by determining if the platform owner desired to add a new user to the platform (block 502). If a new user is to be added (block 502), the platform owner is prompted for a user name of the new user (block 504). Alternatively, if a new user is not to be added to the platform (block 502), the platform owner is prompted to select an existing user name from the list of users already instantiated on the platform (block 506).

After a new user name is entered or after an existing user name is selected, the platform owner associates boot object(s) with the user name (block 508). For example, a particular user may be authorized to boot three different OSs. In that case, the three boot objects associated those three OSs are associated with the user name. Accordingly, when the user having that user name attempts to boot an OS, that user will be authorized to boot any one of the three specified OSs. Conversely, if a particular user name is associated with only one boot object, that user will only be able to boot the OS associated-with that boot object. For example, if the parents in a household are authorized as platform owners, the parents may specify the OSs that their children are allowed to boot. For instance, a sixteen-year-old child in the household may be authorized to boot either Windows 98 or Windows XP®, whereas a seven-year-old child in the household may be authorized to boot only Windows 98.

After the boot object associations have been made, the platform owner is prompted to change the password/user credential required to prove the identity of the platform owner (block 510). If the platform owner desires to change the password/user credentials, the platform owner inputs the new password/user credential (block 512). As noted previously, the password/user credential may be a salted password or any other identity proving mechanism or device. Additionally, the user credential may be text or any hardware or software that is required to prove the identity of the platform owner.

After the password/user credential has been changed (block 512), or if the password/user credential is not to be changed (block 510), the platform owner is prompted to save changes to the trust credentials modified at blocks 502, 504, 506, 508, 510, and 512 (block 514). If the platform owner manifests a desire to save the changes (block 514), the changes are saved (block 516) and the update trust credentials process 500 ends and returns control to its calling routine, which may be, for example, the boot process 400. Alternatively, if the changes to the trust credentials are not to be changed (block 514), the update trust credentials process 500 ends, and returns control to its calling routine.

Although certain apparatus, methods, and articles of manufacture constructed in accordance with the teachings of the invention have been described herein, the scope of coverage of this patent is not limited thereto. On the contrary, this patent covers all apparatuses, methods and articles of manufacture of the teachings of the invention fairly falling within the scope of the appended claims either literally or under the doctrine of equivalents.

1. A method of booting a processor system, the method comprising:
accepting a selection of a desired operating system to be booted;
accepting a user credential associated with a user who has selected the desired operating system to be booted;
determining if the user credential corresponds to the desired operating system to be booted; and
enabling booting of the desired operating system if the user credential corresponds to the desired operating system.

2. A method as defined by claim 1, further comprising determining if the desired operating system comprises a legacy operating system.

3. A method as defined by claim 2, wherein if the desired operating system comprises a legacy operating system, a basic input/output system (BIOS) boot specification determines a boot object for the desired operating system.

4. A method as defined by claim 2, wherein if the desired operating system does not comprise a legacy operating system, a boot next variable option boot object indicates a location of the desired operating system.

5. A method as defined by claim 1, wherein the user credential comprises one or more of a salted password, a portable token, and biometric information.

6. A method as defined by claim 1, wherein determining if the user credential corresponds to the desired operating system to be booted comprises determining if the user credential corresponds to a credential from a platform owner.

7. A method as defined by claim 1, further comprising determining if a trusted boot is disabled and booting the desired operating system if the trusted boot is disabled even if the user credential does not correspond to the desired operating system.

8. A method as defined by claim 1, further comprising enabling a platform owner to modify a list of user credentials and the desired operating systems to which they correspond.

9. A method as defined by claim 1, further comprising determining if a platform owner has been established and enabling a user to enter a platform owner credential if no platform owner has been established.

10. An article of manufacture comprising a machine-accessible medium having a plurality of machine accessible instructions that, when executed, cause a machine to:
accept a selection of a desired operating system to be booted;
accept a user credential associated with a user who has selected the desired operating system to be booted;
determine if the user credential corresponds to the desired operating system to be booted; and
enable booting of the desired operating system if the user credential corresponds to the desired operating system.

11. An article of manufacture as defined by claim 10, further comprising instructions that, when executed, cause a machine to determine if the desired operating system comprises a legacy operating system.

12. An article of manufacture as defined by claim 11, further comprising instructions that, when executed, cause a machine to determine a boot object for the desired operating system from a basic input/output system (BIOS) boot specification if the desired operating system comprises a legacy operating system.

13. An article of manufacture as defined by claim 11, further comprising instructions that, when executed, cause a machine to determine a location of the desired operating system from a boot next variable option boot object if the desired operating system does not comprise a legacy operating system.

14. An article of manufacture as defined by claim 10, wherein the user credential comprises one or more of a salted password, a portable token, and biometric information.

15. An article of manufacture as defined by claim 10, further comprising instructions that, when executed, cause a machine to determine if the user credential corresponds to the desired operating system to be booted by determining if the user credential corresponds to a credential from a platform owner

16. An article of manufacture as defined by claim 10, further comprising instructions that, when executed, cause a machine to determine if a trusted boot is disabled and to boot the desired operating system if the trusted boot is disabled even if the user credential does not correspond to the desired operating system.

17. An article of manufacture as defined by claim 10, further comprising instructions that, when executed, cause a machine to determine if a platform owner has been established and to enable a user to enter a platform owner credential if no platform owner has been established.

18. A system comprising:
a memory; and
a processor coupled to the memory, wherein the processor is programmed to:
accept a selection of a desired operating system to be booted;
accept a user credential associated with a user who has selected the desired operating system to be booted;
determine if the user credential corresponds to the desired operating system to be booted; and
enable booting of the desired operating system if the user credential corresponds to the desired operating system.

19. A system as defined by claim 18, wherein the processor is further programmed to determine if the desired operating system comprises a legacy operating system.

20. A system as defined by claim 19, wherein the processor is further programmed to determine a boot object for the desired operating system from a basic input/output system (BIOS) boot specification if the desired operating system comprises a legacy operating system.

21. A system as defined by claim 19, wherein the processor is further programmed to determine a location of the desired operating system from a boot next variable option boot object if the desired operating system does not comprise a legacy operating system.

22. A system as defined by claim 18, wherein the user credential comprises one or more of a salted password, a portable token, and biometric information.

23. A system as defined by claim 18, wherein the processor is further programmed to determine if the user credential corresponds to the desired operating system to be booted by determining if the user credential corresponds to a credential from a platform owner

24. A system as defined by claim 18, wherein the processor is further programmed to determine if a trusted boot is disabled and to boot the desired operating system if the trusted boot is disabled even if the user credential does not correspond to the desired operating system.

25. An apparatus to control selection of operating system booting, the apparatus comprising:
a permissions table storing user credentials and boot objects corresponding to the user credentials; and
a user verification segment coupled to the permissions table and accepting a selection of a desired operating system to be booted and further accepting a submitted user credential associated with a user who has selected the desired operating system to be booted, the user verification segment determining if the submitted user credential is authorized to boot the desired operating system.

26. An apparatus as defined by claim 25, wherein the user verification segment returns an address of the desired operating system if the submitted user credential is authorized to boot the desired operating system.
